(19) United States
(12) Patent Application Publication
(10) Pub. No.: US 2012/0306254 A1
(43) Pub. Date: Dec. 6, 2012

(54) RECLINING DEVICE

(75) Inventor: Yoshitaka Ishihara, Aichi (JP)

(73) Assignee: Imasen Electric Industrial Co., Ltd., Aichi (JP)

(21) Appl. No.: 13/577,498

(22) PCT Filed: Feb. 26, 2010
(86) PCT No.: PCT/JP2010/053080

§ 371 Date: Aug. 7, 2012

(51) Int. Cl. B60N 2/20

(52) U.S. Cl. 297/354.1

(57) ABSTRACT

An internally-toothed plate 105 and an externally-toothed plate 106 are fitted together so that a portion of an externally-toothed gear 161 of the externally-toothed plate 106 is located in a recess 151 such that the externally-toothed gear 161 a meshes with an internally-toothed gear 151a, and so that a bearing portion 151b of the internally-toothed plate 105 is located in a recess 161. In other words, the externally-toothed plate 106 is fitted into the internally-toothed plate 105. At this time, a seat cushion bracket 121 to which the internally-toothed plate 105 is fixed by laser welding is in contact with an outer peripheral edge 163 at the back side of the recess 161 of the externally-toothed plate 106. As a result, a reclining device with a reduced number of components and size can be obtained.

### TECHNICAL FIELD

The present invention relates to reclining devices for tiltably holding a seat back with respect to a seat cushion of a seat on which a person is seated, and more particularly, to a reclining device suitable for the use for a vehicle seat.

### BACKGROUND ART

Conventionally, various types of devices have been proposed as reclining devices provided to a vehicle seat and the like. A so-called round reclining device as described in Patent Literature 1, for example, is practically used as a small and lightweight reclining device that can be easily assembled to a seat. The round reclining device includes a substantially disk-shaped base plate, a substantially disk-shaped gear plate facing and being combined with the base plate, and a locking mechanism arranged in an internal space formed between facing surfaces of the base plate and the gear plate. The base plate and the gear plate are relatively rotatable around a center shaft and can be adjusted and fixed.

The round reclining device as described above fixes the seat cushion on which an occupant is seated and the seat back tiltably fixed to the seat cushion. The base plate and the gear plate of the round reclining device are fixed to the seat cushion and the seat back, respectively. A practical example of how the base plate and the gear plate are fixed is described in Patent Literature 2. Hereinafter, a conventional device described in Patent Literature 2 will be described with reference to FIGS. 5 to 7. FIG. 5(a) is a front view illustrating the reclining device coupled to the base plate and an arm plate. FIG. 5(b) is a lateral cross-sectional view illustrating the reclining device coupled to the base plate and the arm plate. FIG. 6(a) is a frontal cross-sectional view illustrating the device. FIG. 6(b) is a lateral cross-sectional view illustrating the device. FIG. 7 is a diagram illustrating the device fixed to a vehicle seat.

In the reclining device shown in FIGS. 5 to 7, a base plate 204 is fixed to a seat cushion 202, on which an occupant is seated. A frame 205 is coupled to the base plate 204. An arm plate 206 is fixed to a seat back 203 that is turnably fixed to the seat cushion 202. A lid 207 is coupled to the arm plate 206.

The frame 205 and the lid 207 are components of a reclining device 201. The frame 205 has circular recesses formed by half-blanking an inner side of the disk by pressing. On the other hand, the lid 207 has circular recesses similarly formed by half-blanking an inner side of the disk and an internally-toothed gear 207a provided on an inner periphery surface of the circular recesses. The lid 207 is relatively rotatably fitted into the circular recesses of the frame 205, coaxially with the frame 205. An outer periphery of the frame 205 and an outer periphery of the lid 207 are clamped by a ring-shaped holder 208. Accordingly, the frame 205 and the lid 207 are relatively rotatably held without being separated in the axial direction.

A rotatory cam 209 is arranged in the center between the frame 205 and the lid 207 along the axial direction. A pair of swingable locking teeth 210 is arranged above and below the cam 209. The cam 209 can be rotated by manipulating a manipulation lever 217. Guiding means 212A and 212B are provided to swingably guide the locking teeth 210 along the circular track.

In the reclining device having the above configuration, the cam 209 is rotated by manipulation of the manipulation lever 217 so that the locking teeth 210 are swung along the guiding means 212A and 212B. Teeth of the locking teeth 210 and the internally-toothed gear 207a are engageable and detachable with and from each other, so that turning of the lid 207 with respect to the frame 205 can be controlled.

Next, the coupling structure of the frame 205 and the base plate 204 will be described below. On the outer surface of the frame 205, six columnar protrusions 205a are formed in the circumferential direction, avoiding the locations where the first guiding protrusions 212A and the second guiding protrusions 212B are formed. Each of the protrusions 205a is fitted to a fitting hole 204a formed in the base plate 204. The inner side of the fitting hole 204a and the protrusion 205a are coupled to each other via a welded portion 219. The lid 207 and the arm plate 206 are coupled to each other in the following manner. On the outer surface of the lid 207, six columnar protrusions 207b are formed in the circumferential direction at substantially regular intervals. Each of the protrusions 207b is fitted to a fitting hole 206b formed in the arm plate 206. The inner side of the fitting hole 206b and the protrusion 207b are coupled to each other via the welded portion 219.

However, in the configuration disclosed in Patent Literature 2, the protrusions 205a and 207b are formed on the frame 205 and the lid 207, respectively. Each of the protrusions 205a and 207b is fitted and welded to the fitting hole 204a of the base plate 204 and the fitting hole 206b of the arm plate 206, respectively. Accordingly, there is a disadvantage that the thickness of the reclining device in the width direction increases.

Because the frame 205 and the lid 207 are clamped by the holder 208, the frame 205 and the lid 207 are relatively rotatably held without being separated in the axial direction. Therefore, it is required that the frame 205 and the lid 207 be provided with, in the radial direction thereof, a portion where the holder 208 is fixed. Accordingly, there is also a disadvantage that the outer diameter of the reclining device increases.

Furthermore, an electric reclining device is also employed as a reclining device for a vehicle seat for reclining a seat back with respect to a seat cushion.

Specifically, such a device includes a gear mechanism having a lower frame and an upper frame. The lower frame is fixed to the side of the seat cushion and has an internally-toothed gear. The upper frame is fixed to the side of the seat back and has an externally-toothed gear having slightly less teeth than the internally-toothed gear of the lower frame. The externally-toothed gear meshes with the internally-toothed gear. It is possible to continuously adjust a turning angle of the upper frame with respect to the lower frame by rotating the meshing position of the gears. A combination of a pair of wedge members and a cam, which is located between the lower frame and the upper frame, is used as a mechanism to rotate the meshing position of the gears. In other words, the cam is rotated by electric manipulation, and the wedge members are rotated while pressing the gears of the lower frame and the upper frame by the wedge members in the meshing direction, thereby rotating the meshing position.

Such a reclining device is described in Patent Literature 3, for example. A conventional device described in Patent Literature 3 will be described below with reference to FIGS. 8 to 10. FIG. 8 is an exploded perspective view illustrating the reclining device. FIG. 9 is a side view illustrating a gear mechanism of the device shown in FIG. 8. FIG. 10 is a cross-sectional view illustrating the gear mechanism taken along the line C-C of FIG. 8. In this reclining device, an upper plate 341 is fixed to an upper arm that is fixed to a seat back, by fitting protrusions in fitting holes formed in the upper arm. The upper plate 341 is formed by half-blanking a metal plate, and has recesses 342 formed by recessing the upper plate 341 from outside in a circular shape. The recesses 342 are provided with an internally-toothed gear 342a. In the center portion surrounded by the recesses 342, an annular bearing portion 341a, which has an opening in the center thereof, is provided concentrically with the recesses 342. The annular bearing portion 341a projects outward. The upper plate 341 constitutes a first frame together with the upper arm, and is substantially integrated with the seat back frame.

A lower plate 343, which is fixed to a lower arm that is fixed to the seat cushion by fitting protrusions to fitting holes formed in the lower arm, is formed by half-blanking a metal plate. The lower plate 343 has annular portions 344 projected annularly inward (toward the side of the upper plate 341). The outer diameter of the annular portions 344 is smaller than the inner diameter of the recesses 342. The annular portions 344 are provided with an externally-toothed gear 344a. Annular bearings 345 having the outer diameter similar to the inner diameter of the annular portions 344 are pressed and fixed to the annular portions 344. The inner diameter of the bearing 345 is set to be larger than the outer diameter of the bearing portion 341a. The lower plate 343 constitutes a second frame together with the lower arm and is substantially integrated with the seat cushion frame.

The number of the teeth of the internally-toothed gear 342a is larger than that of the externally-toothed gear 344a by a predetermined number (one tooth). The teeth of the internally-toothed gear 342a are formed so as to mesh with the externally-toothed gear 344a. As shown in FIG. 9, because a central axis 01 of the internally-toothed gear 342a and a central axis O2 of the externally-toothed gear 344a are eccentric to each other, the internally-toothed gear 342a and the externally-toothed gear 344a are relatively rotated while maintaining the meshing of the internally-toothed gear 342a and the externally-toothed gear 344a. In other words, when the meshing position moves, the upper plate 341 turns with respect to the lower plate 343 every one rotation by an angle corresponding to the difference in the number of the teeth.

In the state where the lower plate 343 is fitted to the upper plate 341, a ring-shaped holder 340 made from a metal plate is attached to the outer periphery of the lower plate 343 and the upper plate 341. Accordingly, the holder 340 prevents the upper plate 341 and the lower plate 343 from being fallen off in the axial direction in the state where the meshing position can move.

An annular space is formed between the inner periphery surface of the bearing 345 and the outer periphery surface of the bearing portion 341a because of the eccentric meshing of the internally-toothed gear 342a and the externally-toothed gear 344a. In the annular space, a pair of wedges 346 and 347 is fitted, which is formed separately in the circumferential direction, with the angular position where the internally-toothed gear 342a meshes with the externally-toothed gear 344a being a reference position.

Each of the wedges 346 and 347 is formed in a minor arc shape symmetrical to each other, and corresponds to the shape of the space formed between the inner periphery surface of the bearing 345 and the outer periphery surface of the bearing portion 341a. The wedges 346 and 347 are formed so that the width thereof in the radial direction increases toward the end side in the circumferential direction, which is the side of the angular position where the internally-toothed gear 342a meshes with the externally-toothed gear 344a. Each end of an Ω-shaped spring 348, which is arranged at the outer circumference side of the wedges 346 and 347, is latched at the wedges 346 and 347. Therefore, the wedges 346 and 347 are biased so that the wedges 346 and 347 are pushed outward from each other, in other words, the wedges 346 and 347 are biased to the side where the eccentricity of the internally-toothed gear 342a and the externally-toothed gear 344a increases. Accordingly, the wedges 346 and 347 hold the meshing position of the internally-toothed gear 342a and the externally-toothed gear 344a.

A cam 349 inserted into the bearing portion 341a of the upper plate 341 from outside has a shaft portion 349a formed in a cylindrical shape having the outer diameter similar to the inner diameter of the bearing portion 341a. Accordingly, the cam 349 is rotatably supported by the upper plate 341 at the shaft portion 349a. In addition, the cam 349 has a cam portion 349b. The cam portion 349b extends outward in the radial direction in an arc shape at the angular position opposite from the meshing position of the internally-toothed gear 342a and the externally-toothed gear 344a at one side of the axial direction of the shaft portion 349a. The cam portion 349b is arranged between the pair of the wedges 346 and 347 with a space in the circumferential direction.

In such a structure, when the cam 349 is rotated by a motor, one of the wedges 346 and 347 is pressed by the cam portion 349b in accordance with the rotation direction. As a result, the spring 348 is elastically deformed, and the wedges 346 and 347 are rotated together. Accordingly, the meshing position of the internally-toothed gear 342a and the externally-toothed gear 344a moves, and thus the upper plate 341 can be turned with respect to the lower plate 343.

However, according to the configuration described in Patent Literature 3, protrusions are provided to each of the upper plate 341 and the lower plate 343. These protrusions are fitted in and welded to fitting holes of each of an upper arm 323 and a lower arm 321. Accordingly, there is a disadvantage that the thickness of the reclining device in the width direction increases.

The upper plate 341 and the lower plate 343 are relatively rotatably held without being separated in the axial direction, by being clamped by the holder 340. Therefore, it is required that the upper plate 341 and the lower plate 343 be provided with, in the radial direction thereof, a portion where the holder 340 is fixed. Accordingly, there is also a disadvantage that the outer diameter of the reclining device increases.

### SUMMARY OF THE INVENTION

### Problem to be Solved by the Invention

The present invention has been made to solve the above-described problems, and an object of the present invention is to provide a reclining device with a reduced number of components and size.

### Solution to the Problems

In order to solve the above-described problems, an reclining device according to an aspect of the present invention includes: a substantially disk-shaped base plate to be fixed to one of a bracket of a seat cushion of a seat on which an occupant is seated and a bracket of a seat back tiltable with respect to the seat cushion; a substantially disk-shaped gear plate rotatably fixed to and facing the base plate, the gear plate having an internal gear; a plurality of locking gears guided to be movable only in a radial direction and fixed to the base plate, the locking gear having an external gear capable of meshing with the internal gear of the gear plate; a cam for controlling an outward movement of the locking gears in a radial direction, the cam allowing the locking gears to mesh with the internal gear of the gear plate; a spring for rotationally biasing the cam in a direction where the locking gears mesh with the internal gear; a lever plate rotating integrally with the cam and engaging with protrusions provided on the locking gears, the lever plate controlling an inward movement of the locking gears in a radial direction; a center shaft inserted roughly at the center of the base plate and the gear plate, the center shaft being capable of rotating integrally with the cam; and a manipulation member coupled to the center shaft, the manipulation member being capable of rotationally driving the center shaft against an biasing force of the spring. An outer peripheral edge of the gear plate is formed so as to cover an outer peripheral edge of the base plate; the base plate turnably fits to the gear plate; the bracket of one of the seat cushion and the seat back to which the gear plate is fixed has a fixing hole; and the gear plate to which the base plate is fitted concentrically with the fixing hole is fixed so that the outer peripheral edge of the base plate is in contact with the bracket to which the gear plate is fixed.

According to this configuration, the gear plate is fixed to the bracket in the following manner. That is, the outer peripheral edge of the gear plate covers the outer peripheral edge of the base plate. The base plate is turnably fitted to the gear plate. The bracket of the seat cushion or the seat back is in contact with the outer peripheral edge of the base plate. Accordingly, the following effects can be obtained. The base plate is not removed from the gear plate. In addition, a cover to keep the gear plate fitted to the base plate is not necessary unlike in a related art. Furthermore, the reclining device can be manufactured with a reduced number of components and can be downsized, which leads to reduction in cost.

Preferably, the gear plate and the base plate are fixed to the brackets of the seat cushion and the seat back by laser welding.

According to this configuration, because the gear plate is fixed to the bracket of the seat cushion or the seat back by laser welding, the outer peripheral edge of the gear plate to be welded is not required to be thick. Accordingly, the reclining device can be downsized more.

In order to solve the above-described problems, an reclining device according to another aspect of the present invention includes: a substantially disk-shaped internally-toothed plate fixed to one of a bracket of a seat cushion of a seat on which an occupant is seated and a bracket of a seat back tiltable with respect to the seat cushion, the internally-toothed plate having an internally-toothed gear; a substantially disk-shaped externally-toothed plate having an externally-toothed gear that has less teeth than the internally-toothed gear, the externally-toothed gear meshing with the internally-toothed gear; a bearing and wedges arranged between a bearing portion of the internally-toothed plate and a bearing portion of the externally-toothed plate, the bearing and the wedges controlling rotation of the internally-toothed plate and the externally-toothed plate; and a cam shaft inserted roughly at the center of the internally-toothed plate and the externally-toothed plate, the cam shaft being capable of pressing the wedges. The externally-toothed gear is arranged on an outer peripheral edge of the externally-toothed plate; the externally-toothed plate is fitted into the internally-toothed plate so that the internally-toothed gear meshes with the externally-toothed gear; the bracket of one of the seat cushion and the seat back to which the internally-toothed plate is fixed has a fixing hole; and the internally-toothed plate to which the externally-toothed plate is fitted concentrically with the fixing hole is fixed so that the outer peripheral edge of the externally-toothed plate is in contact with the bracket to which the internally-toothed plate is fixed.

According to this configuration, the externally-toothed plate is fitted into the internally-toothed plate, and the bracket of the seat cushion or the seat back to which the internally-toothed plate is fixed is in contact with the outer peripheral edge of the externally-toothed plate. Therefore, the following effects can be obtained: externally-toothed plate is not removed from the internally-toothed plate; a holder to keep the internally-toothed plate fitted to the externally-toothed plate is not necessary unlike in a related art; and the reclining device can be manufactured with a reduced number of components and can be downsized, which leads to reduction in cost.

In addition, because the externally-toothed plate is fitted into the internally-toothed plate so that the externally-toothed gear is arranged on the outer peripheral edge of the externally-toothed plate and the externally-toothed gear meshes with the internally-toothed gear provided to the internally-toothed plate, the thickness of the reclining device in the width direction can be reduced.

Preferably, the internally-toothed plate and the externally-toothed plate are fixed to the bracket of the seat cushion and the bracket of the seat back, respectively, by laser welding.

According to this configuration, because the internally-toothed plate and the externally-toothed plate are fixed to the bracket of the seat cushion and the bracket of the seat back, respectively, by laser welding, the outer peripheral edge of the internally-toothed plate to be welded is not required to be thick. Accordingly, the reclining device can be downsized compared to a related art.

### Effects of the Invention

As described above, according to the present invention, a reclining device with a reduced number of components and size can be obtained.

### BRIEF DESCRIPTION OF THE DRAWINGS

FIG. 1 is a schematic view illustrating a seat to which a reclining device according to a first embodiment of the present invention is fixed.

FIG. 2 is a cross-sectional view taken along the line A-A of FIG. 1.

FIG. 3 is a cross-sectional view taken along the line B-B of FIG. 2.

FIG. 4 is a cross-sectional view taken along the line A-A of FIG. 1, schematically illustrating a seat to which a reclining device according to a second embodiment of the present invention is fixed.

FIG. 5(a) is a front view illustrating a reclining device according to a related art on which the present invention is based, where the reclining device is coupled to a base plate and an arm plate.

FIG. 5(b) is a lateral cross-sectional view illustrating the reclining device according to a related art on which the present invention is based, where the reclining device is coupled to the base plate and the arm plate.

FIG. 6(a) is a frontal cross-sectional view illustrating the device shown in FIG. 5.

FIG. 6(b) is a lateral cross-sectional view illustrating the device shown in FIG. 5.

FIG. 7 is a diagram illustrating the device shown in FIG. 5 fixed to a vehicle seat.

FIG. 8 is an exploded perspective view illustrating a reclining device according to another related art on which the present invention is based.

FIG. 9 is a side view illustrating a gear mechanism of the reclining device shown in FIG. 8.

FIG. 10 is a cross-sectional view illustrating the gear mechanism taken along the line C-C of FIG. 8.

### MODE FOR CARRYING OUT THE INVENTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing

### First Embodiment

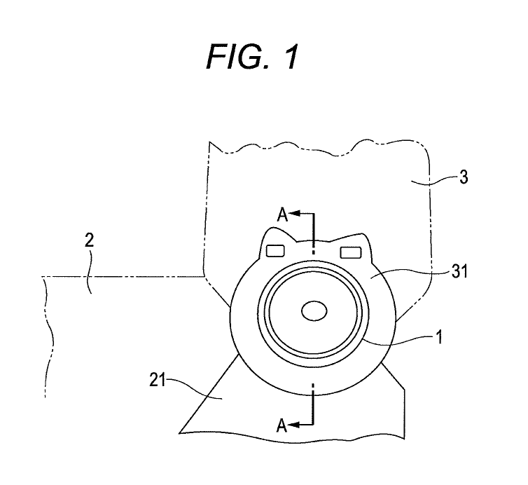

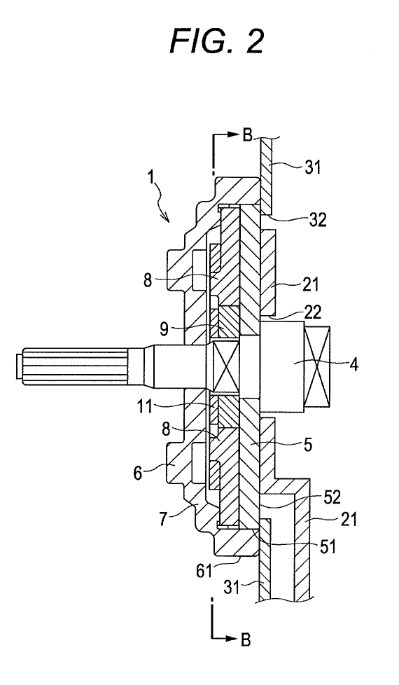

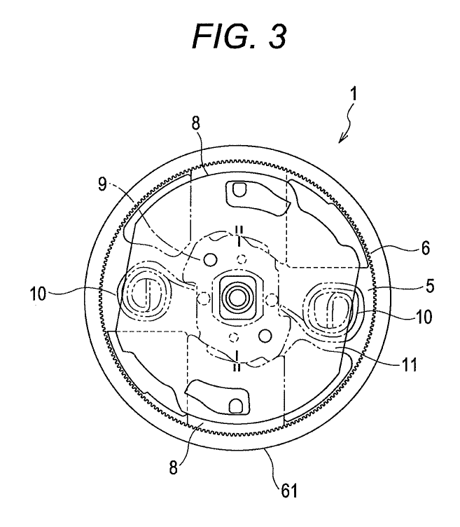

A reclining device according to a first embodiment of the present invention will be described in detail with reference to the drawings. FIG. 1 is a schematic view illustrating a seat to which the reclining device according to the first embodiment is fixed. FIG. 2 is a cross-sectional view taken along the line A-A of FIG. 1. FIG. 3 is a cross-sectional view taken along the line B-B of FIG. 2.

A reclining device 1 can tiltably fix a seat back 3 as a backrest to a seat cushion 2, on which an occupant is seated. The reclining device 1 is provided between a seat cushion bracket 21 fixed to the seat cushion 2 and a seat back bracket 31 fixed to the seat back 3.

The seat back bracket 31 has a fixing hole 32 formed at a portion where the reclining device 1 is fixed. On the other hand, the seat cushion bracket 21 has an insertion hole 22, into which a center shaft 4 as a rotation axis is inserted.

Next, the reclining device 1 will be described. In the reclining device 1, a substantially disk-shaped base plate 5 and a substantially disk-shaped gear plate 6 are facing and combined with each other. The reclining device 1 has a round outer shape, and the center shaft 4 is inserted at the center of the reclining device 1. Accordingly, the base plate 5 and the gear plate 6 are relatively rotatable around the center shaft 4. An outer peripheral edge 61 of the gear plate 6 covers an outer peripheral edge 51 of the base plate 5. The base plate 5 is rotatably fitted to the gear plate 6.

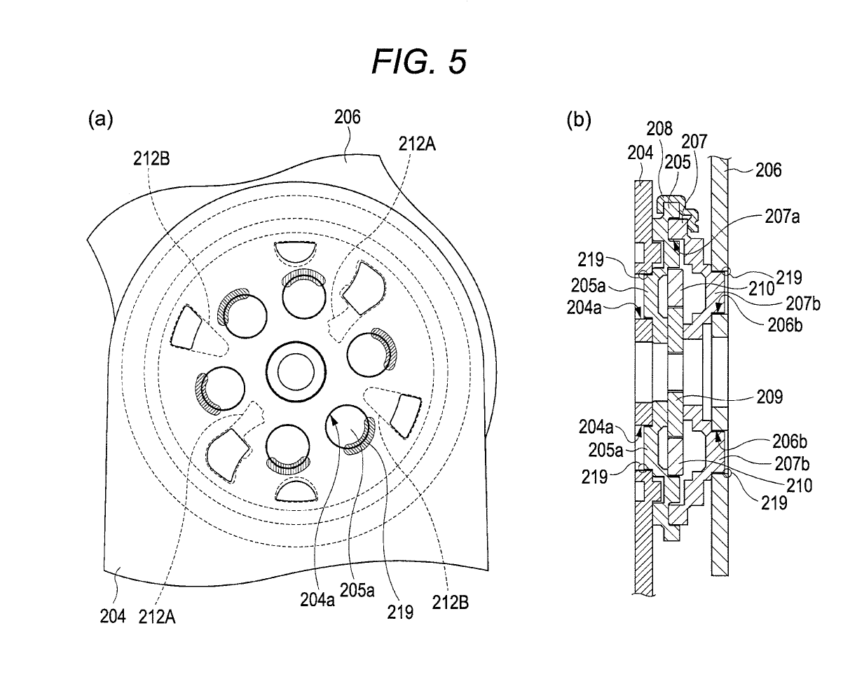

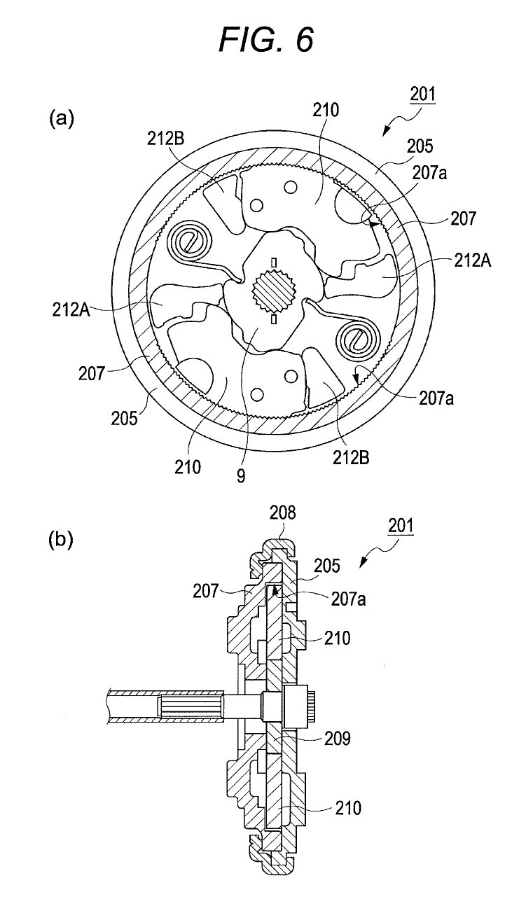

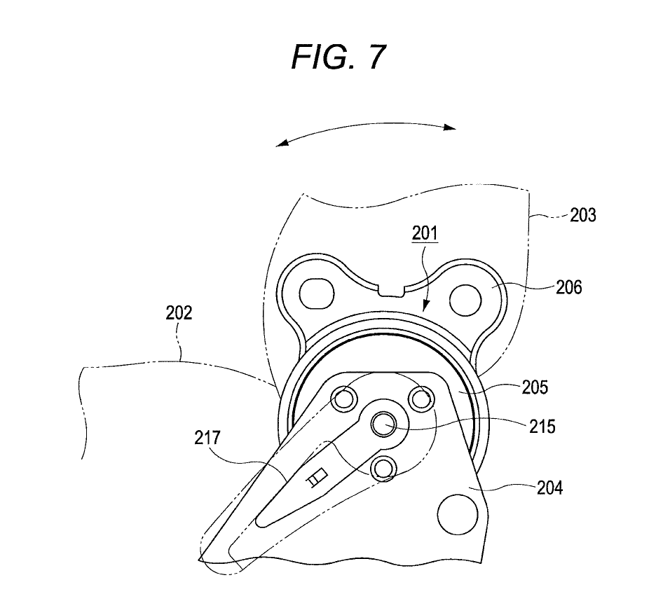

A cavity (space) 7 is formed at the portion where the base plate 5 is fitted to the gear plate 6. The cavity 7 houses a locking mechanism. The locking mechanism includes two locking gears 8 and 8, a central cam 9, two spiral springs 10 and 10, and a lever plate 11. The locking mechanism has a similar configuration to that of a device of a related art already described with reference to FIG. 5 and other drawings. Therefore, detailed description of the locking mechanism is omitted.

The outer peripheral edge 61 of the gear plate 6 is larger than the fixing hole 32 formed in the seat back bracket 31. The gear plate 6 is fixed to the seat back bracket 31 by laser-welding the outer peripheral edge 61 to the seat back bracket 31 so as to cover the fixing hole 32. At this time, the base plate 5 is turnably fitted to the gear plate 6. Furthermore, as shown in FIG. 2, an outer surface 52 of the base plate 5 is in contact with the seat back bracket 31. Therefore, the base plate 5 can rotate without being removed from the gear plate 6. As a result, a function as a reclining device can be achieved without requiring a cover member to keep the base plate 5 fitted to the gear plate 6, unlike in a related art.

Next, assembly of the reclining device 1 according to the first embodiment will be described. First, the reclining device 1 is assembled as shown in FIG. 2. That is, the locking gears 8 and 8, the central cam 9, the spiral springs 10 and 10, and the lever plate 11 are placed on the base plate 5. Subsequently, the gear plate 6 is fitted and the center shaft 4 is inserted. Then, the assembled reclining device 1 is aligned to the fixing hole 32 of the seat back bracket 31 as shown in FIG. 3. The outer peripheral edge 61 of the gear plate 6 is fixed to the seat back bracket 31 by laser welding with the seat back bracket 31 being in contact with the base plate 5. Furthermore, the seat cushion bracket 21 is fixed to the outer surface 52 of the base plate 5 by laser welding.

In this manner, in the reclining device according to the first embodiment, the outer peripheral edge 61 of the gear plate 6 covers the outer peripheral edge 51 of the base plate 5. The base plate 5 is turnably fitted to the gear plate 6. The gear plate 6 is fixed to the seat back bracket 31 by laser-welding the outer peripheral edge 61 to the seat back bracket 31 so that the seat back bracket 31 is in contact with the outer peripheral edge 51 of the base plate 5. Therefore, a cover to fit the gear plate 6 to the base plate 5 is not necessary. Furthermore, the number of the components of the reclining device can be reduced and the reclining device can be downsized. Hence, cost is also reduced.

### Second Embodiment

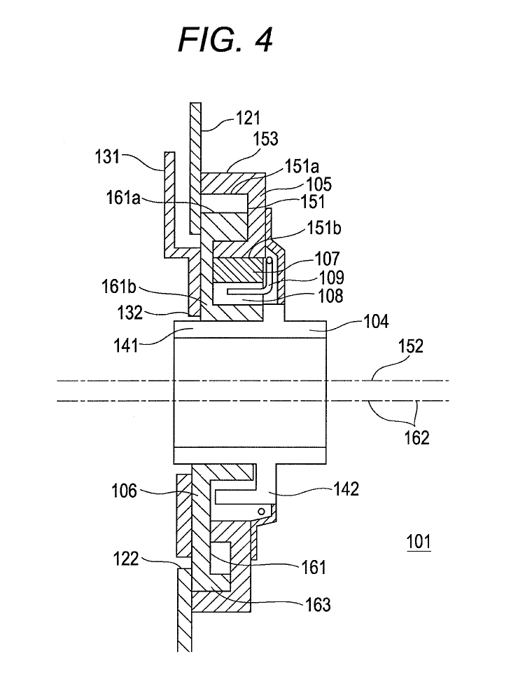

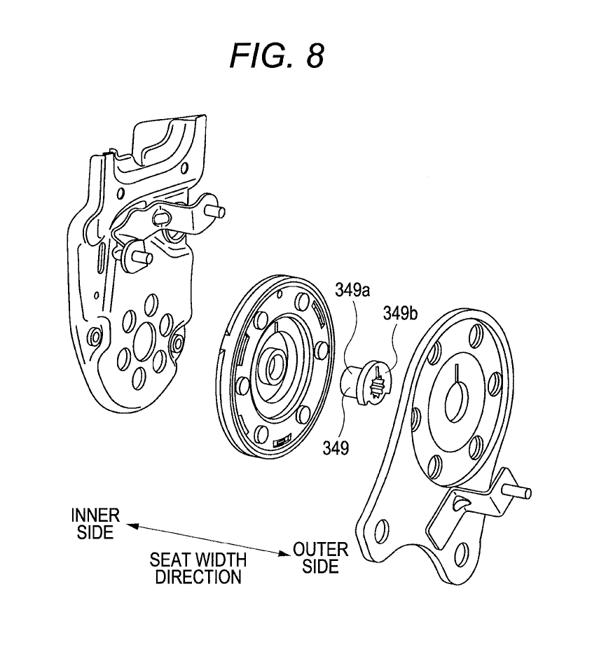

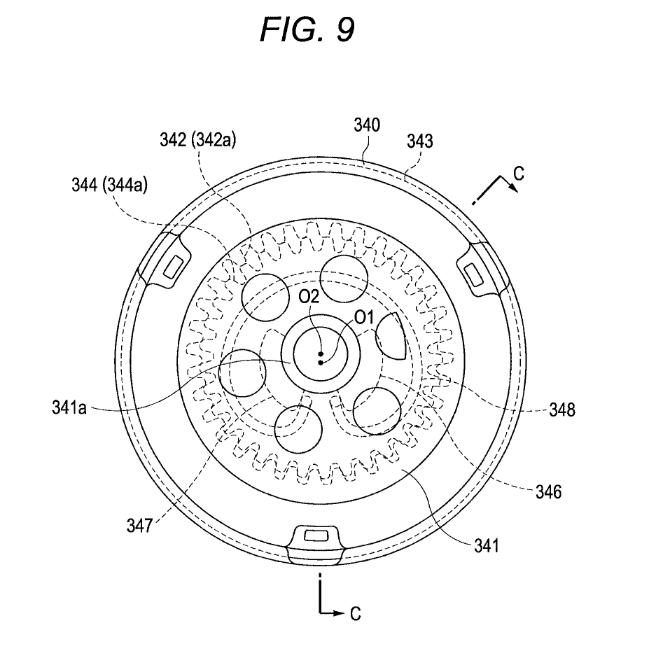

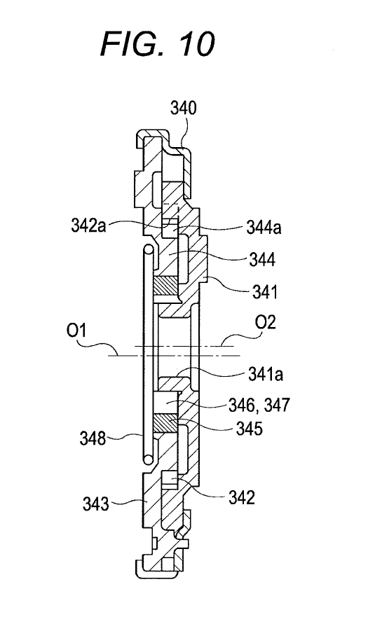

Next, a reclining device according to a second embodiment of the present invention will be described in detail with reference to the drawings. The schematic configuration of the seat to which the reclining device is fixed is as shown in FIG. 1, except for the reference signs. FIG. 4 is a cross-sectional view taken along the line A-A of FIG. 1, schematically illustrating the seat to which the reclining device is fixed. The reclining device according to the second embodiment is based on the device of a related art described in Patent Literature 3 shown in FIGS. 8 to 10. Detailed explanation on similar portions to the device of Patent Literature 3 is omitted.

A reclining device 101 according to the second embodiment can tiltably fix the seat back 3 as a backrest to the seat cushion 2, on which an occupant is seated. The reclining device is provided between a seat cushion bracket 121 fixed to the seat cushion 2 and a seat back bracket 131 fixed to the seat back 3.

The seat cushion bracket 121 has a fixing hole 122 formed at a portion where the reclining device 101 is fixed. On the other hand, the seat back bracket 131 has an insertion hole 132, into which a cam shaft 104 as a rotation axis is inserted.

The reclining device 101 includes: an internally-toothed plate 105 fixed to the seat cushion bracket 121; an externally-toothed plate 106 fixed to the seat back bracket 131; a bearing 107; at least a pair of wedges 108 and 108; a spring 109; and the cam shaft 104.

The internally-toothed plate 105 is formed by half-blanking a metal plate. The internally-toothed plate 105 has a recess 151 formed in a circular shape. An internally-toothed gear 151 a is formed at the recess 151. Furthermore, in the center of the recess 151, a cylindrical bearing portion 151b having an opening in the center thereof is formed concentrically with the recess 151. The cylindrical bearing portion 151b projects outward. The internally-toothed plate 105 is fixed to the seat cushion bracket 121 by laser-welding an outer peripheral edge 153 thereof to the seat cushion bracket 121, and is substantially integrated with a seat cushion frame.

The externally-toothed plate 106 is formed by half-blanking a metal plate. A recess 161 is formed inside the externally-toothed plate 106 (at the side of the internally-toothed plate 105) in a protruding manner. The outer diameter of the recess 161 is smaller than the inner diameter of the recess 151. An externally-toothed gear 161a is formed at an outer peripheral edge 163 of the recess 161. Furthermore, in the center of the recess 161, a cylindrical bearing portion 161b having an opening in the center thereof is formed. The bearing portion 161b is formed concentrically with the recess 161 and projects outward. The back side of the recess 161 is fixed to the seat back bracket 131 by laser welding. Accordingly, the externally-toothed plate 106 is substantially integrated with a seat back frame.

The number of the teeth of the internally-toothed gear 151a is larger than that of the externally-toothed gear 161a by a predetermined number (one tooth). The teeth of the internally-toothed gear 151a are formed so as to mesh with the externally-toothed gear 161 a. A central axis 152 of the internally-toothed gear 151 a and a central axis 162 of the externally-toothed gear 161 a are eccentric to each other. Accordingly, the internally-toothed gear 151 a and the externally-toothed gear 161 a are relatively rotated with the internally-toothed gear 151a meshing with the externally-toothed gear 161a. In other words, when the meshing position moves, the internally-toothed plate 105 turns with respect to the externally-toothed plate 106 every one rotation by an angle corresponding to the difference in the number of the teeth.

The internally-toothed plate 105 and the externally-toothed plate 106 are arranged so that the externally-toothed gear 161 of the externally-toothed plate 106 is fitted into the recess 151 and the externally-toothed gear 161a meshes with the internally-toothed gear 151a. In addition, the internally-toothed plate 105 fits to the externally-toothed plate 106 so that the bearing portion 151b of the internally-toothed plate 105 is located inside the recess 161. That is, the externally-toothed plate 6 is fitted into the internally-toothed plate 5. Accordingly, the thickness of the reclining device 101 in the width direction can be reduced.

Furthermore, at this time, the seat cushion bracket 121 to which the internally-toothed plate 105 is fixed by laser welding is in contact with the outer peripheral edge 163 at the back side of the recess 161 of the externally-toothed plate 106. As a result, the function of the reclining device can be achieved with the externally-toothed plate 106 fitted into the internally-toothed plate 105 and without requiring a holder to keep the internally-toothed plate 105 fitted to the externally-toothed plate 106 unlike in a related art.

The bearing 107 has the outer diameter similar to the inner diameter of the recess 151, and is formed in an annular shape. The bearing 107 is fixed by being pressed into the recess 151. The inner diameter of the bearing 107 is larger than the outer diameter of the bearing portion 161b.

The pair of the wedges 108 and 108 is formed separately in the circumferential direction, with the angle where the internally-toothed gear 151a meshes with the externally-toothed gear 161 a being a reference position. The wedges 108 are provided in an annular space. The annular space is formed between an inner periphery surface of the bearing 107 and an outer periphery surface of the bearing portion 161b provided to the externally-toothed plate 106 because of eccentric meshing of the internally-toothed gear 151a and the externally-toothed gear 161a.

Each of the wedges 108 and 108 is formed in an arc shape symmetrical to each other, the shape corresponding to the shape of the space formed between the inner periphery surface of the bearing 107 and the outer periphery surface of the bearing portion 161b provided to the externally-toothed plate 106. Furthermore, the pair of the wedges 108 and 108 is formed so that the width of the wedges 108 and 108 in the radial direction increases toward the end side in the circumferential direction, which is the side of the angular position where the internally-toothed gear 151a meshes with the externally-toothed gear 161a.

The spring 109 is formed in an Ω shape. Each end of the spring 109 is latched at the outer circumference side of the wedges 108 and 108. Therefore, the spring 109 is biased so that the wedges 108 and 108 are pushed outward from each other. In other words, the spring 109 is biased to the side where the eccentricity of the internally-toothed gear 151 a and the externally-toothed gear 161 a increases. Accordingly, the wedges 108 and 108 can hold the meshing position of the internally-toothed gear 151a and the externally-toothed gear 161a.

The cam shaft 104 is inserted into the bearing portion 161b of the externally-toothed plate 106 from outside. The cam shaft 104 has a shaft portion 141. The shaft portion 141 is formed in a cylindrical shape, and has the outer diameter similar to the inner diameter of the bearing portion 161b. In addition, the cam shaft 104 is turnably supported by the externally-toothed plate 106 at the shaft portion 141. Furthermore, the cam shaft 104 has a cam portion 142. The cam portion 142 extends outward in the radial direction in an arc shape at the angular position opposite from the meshing position of the internally-toothed gear 151a and the externally-toothed gear 161a at one side of the axial direction of the shaft portion 141. The cam portion 142 is arranged between the pair of the wedges 108 and 108 with a space in the circumferential direction.

In the reclining device 101 having the above-described structure, when the cam shaft 104 is rotated by a motor (not shown), one of the wedges 108 and 108 is pressed by the cam portion 142 in accordance with the rotation direction. As a result, the wedges 108 and 108 are rotated together while elastically deforming the spring 109. Accordingly, the meshing position of the internally-toothed gear 151 a and the externally-toothed gear 161a moves, and thus the externally-toothed plate 106 is turned with respect to the internally-toothed plate 105.

In this invention, the internally-toothed plate 105 is fixed to the seat cushion bracket 121 and the externally-toothed plate 106 is fixed to the seat back bracket 131. Accordingly, the externally-toothed plate 106 is turned with respect to the internally-toothed plate 105. However, it is needless to say that a similar effect can be obtained even if this relationship is reversed.

As described above, in the reclining device according to the second embodiment, the internally-toothed plate 105 and the externally-toothed plate 106 are arranged so that the externally-toothed gear 161 of the externally-toothed plate 106 is fitted into the recess 151 and the externally-toothed gear 161 a meshes with the internally-toothed gear 151a. In addition, the internally-toothed plate 105 fits to the externally-toothed plate 106 so that the bearing portion 151 b of the internally-toothed plate 105 is located inside the recess 161. In other words, the externally-toothed plate 106 is fitted into the internally-toothed plate 105. At this time, the seat cushion bracket 121 to which the internally-toothed plate 105 is fixed by laser welding is in contact with the outer peripheral edge 163 at the back side of the recess 161 of the externally-toothed plate 106. As a result, because the externally-toothed plate 106 is not removed from the internally-toothed plate 105, a holder to keep the internally-toothed plate 105 fitted to the externally-toothed plate 106 is not necessary, unlike in a related art. Accordingly, the reclining device can be downsized with a reduced number of components, which leads to reduction in cost.

This application is based on Japanese Patent Application No. 2008-328900 and Japanese Patent Application No. 2008-328901, both of which were filed in Japan on Dec. 25, 2008 by the same applicant, and the entire contents of which are incorporated herein by reference. Furthermore, the entire contents of Patent Literature 1, Patent Literature 2, and Patent Literature 3, which are referenced as background arts of the present invention, are incorporated herein by reference.

The specific embodiments of the present invention are described above for an illustrative purpose. The description is not intended to be comprehensive or to limit the present invention to the above-described embodiments. It is obvious for those skilled in the art that various modifications and changes are possible in light of the above description.

### INDUSTRIAL APPLICABILITY

The reclining device according to the present invention is industrially useful because the reclining device can be manufactured with a reduced number of components and size.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

### DESCRIPTION OF REFERENCE SIGNS

1 Reclining device

2 Seat cushion

21 Seat cushion bracket

22 Insertion hole

3 Seat back

31 Seat back bracket

32 Fixing hole

4 Center shaft

5 Base plate

51 Outer peripheral edge

52 Outer surface

6 Gear plate

61 Outer peripheral edge

7 Cavity (space)

8 Locking gear

9 Cam

10 Spiral spring

11 Lever plate

101 Reclining device

102 Seat cushion

121 Seat cushion bracket

122 Fixing hole

103 Seat back

131 Seat back bracket

132 Insertion hole 4 Cam shaft

141 Shaft portion

142 Cam portion

105 Internally-toothed plate

151 Recess

151a Internally-toothed gear

151b Bearing portion

152 Central axis

153 Outer peripheral edge

106 Externally-toothed plate

161 Recess

161a Externally-toothed gear

161b Bearing portion

162 Central axis

163 Outer peripheral edge

107 Bearing

108 Wedge

109 Spring

### Citation List

Patent Literature 1: Japanese Patent No. 3343039
Patent Literature 2: Japanese Patent Application Laid-Open No. 2008-272036
Patent Literature 3: Japanese Patent Application Laid-Open No. 2008-245824

1. A reclining device comprising:
a substantially disk-shaped base plate to be fixed to one of a bracket of a seat cushion of a seat, on which an occupant is seated, and a bracket of a seat back tiltable with respect to the seat cushion;
a substantially disk-shaped gear plate rotatably fixed to and facing the base plate, the gear plate having an internal gear;
a plurality of locking gears guided to be movable only in a radial direction and fixed to the base plate, the locking gears having an external gear capable of meshing with the internal gear of the gear plate;
a cam for controlling an outward movement of the locking gears in the radial direction, the cam allowing the locking gears to mesh with the internal gear of the gear plate;
a spring for rotationally biasing the cam in a direction where the locking gears mesh with the internal gear;
a lever plate rotating integrally with the cam and engaging with protrusions provided on the locking gears, the lever plate controlling an inward movement of the locking gears in a radial direction;
a center shaft inserted roughly at the center of the base plate and the gear plate, the center shaft being capable of rotating integrally with the cam; and
a manipulation member coupled to the center shaft, the manipulation member being capable of rotationally driving the center shaft against an biasing force of the spring,
wherein an outer peripheral edge of the gear plate is formed so as to cover an outer peripheral edge of the base plate and the base plate turnably fits to the gear plate, and
wherein the bracket of one of the seat cushion and the seat back to which the gear plate is fixed has a fixing hole, and the gear plate to which the base plate is fitted concentrically with the fixing hole is fixed so that the outer peripheral edge of the base plate is in contact with the bracket to which the gear plate is fixed.

2. The reclining device according to claim 1, wherein the gear plate and the base plate are fixed to the brackets of the seat cushion and the seat back by laser welding.

3. A reclining device comprising:
a substantially disk-shaped internally-toothed plate fixed to one of a bracket of a seat cushion of a seat on which an occupant is seated and a bracket of a seat back tiltable with respect to the seat cushion, the internally-toothed plate having an internally-toothed gear;
a substantially disk-shaped externally-toothed plate having an externally-toothed gear that has less teeth than the internally-toothed gear, the externally-toothed gear meshing with the internally-toothed gear;
a bearing and wedges arranged between a bearing portion of the internally-toothed plate and a bearing portion of the externally-toothed plate, the bearing and the wedges controlling rotation of the internally-toothed plate and the externally-toothed plate; and
a cam shaft inserted roughly at the center of the internally-toothed plate and the externally-toothed plate, the cam shaft being capable of pressing the wedges,
wherein the externally-toothed gear is arranged on an outer peripheral edge of the externally-toothed plate,
wherein the externally-toothed plate is fitted into the internally-toothed plate so that the internally-toothed gear meshes with the externally-toothed gear, and
wherein the bracket of one of the seat cushion and the seat back to which the internally-toothed plate is fixed has a fixing hole, and the internally-toothed plate to which the externally-toothed plate is fitted concentrically with the fixing hole is fixed so that the outer peripheral edge of the externally-toothed plate is in contact with the bracket to which the internally-toothed plate is fixed.

4. The reclining device according to claim 3, wherein the internally-toothed plate and the externally-toothed plate are fixed to the bracket of the seat cushion and the bracket of the seat back, respectively, by laser welding.
